(19) United States
(12) Patent Application Publication
(10) Pub. No.: US 2021/0216965 A1
(43) Pub. Date: Jul. 15, 2021

(54) OPTIMIZING RETURN LOCATIONS IN A NETWORK

(71) Applicant: International Business Machines Corporation, Armonk, NY (US)

(72) Inventors: Ajay Ashok DESHAPANDE, Pleasantville, NY (US); Ali KOC, White Plains, NY (US); Brian Leo QUANZ, Yorktown Heights, NY (US); Jae-Eun PARK, Dutchess, NY (US); Yingjie LI, Chappaqua, NY (US); Christopher Scott MILITE, Southbury, CT (US); Xuan LIU, Yorktown Heights, NY (US); Chandrasekhar NARAYANASWAMI, Wilton, CT (US); Yada ZHU, Westchester, NY (US)

(21) Appl. No.: 16/740,052

(22) Filed: Jan. 10, 2020

(51) Int. Cl. G06Q 10/08; G06Q 10/06

(52) U.S. Cl. CPC G06Q 10/0837; G06Q 10/06375; G06Q 10/08345

(57) ABSTRACT

The embodiments herein provide techniques for selecting an optimal return location from a plurality of candidate return locations for returning an item based on an expected recovery associated with each location. As discussed above, using predesignated return location(s) ignores many factors that can increase costs that affect returning items such as shipping costs, inventory, handling costs, operational transfer costs, as well as several predicted costs. Further, these techniques do not consider expected future revenue (which can offset these costs). In one embodiment, a net expected recovery is determined for each location using the costs and future revenues discussed above. By comparing the net expected recovery associated with each candidate return location, the optimal return location can be identified.

### BACKGROUND

The present invention relates to selecting a location from a plurality of candidate return locations to ship a returned item.

When returning an item through the mail (rather than returning the item to a store), many retailers require the customer to ship the item to a central location. That is, the retailer may instruct the customers in each country to ship returned items to the same location. At most, a retailer may have divide a country into two or three regions where customers in each region return items to a designated return location in that region. While this may reduce the shipping costs (relative to using one location), the return locations (e.g., a distribution center) may have too many of the items which means the items must be transferred to another distribution center.

Retailers that support online sales and also have physical stores can permit a customer to return items either through the mail to a central location or in person at the physical stores. This return policy also does not consider the current inventory of the physical stores, or demand for the items at different locations and channels (e.g., online versus walk-in sales) and regions. If a store already has too much of the item, the retailer may have to pay to ship the item to a different store or sell the product at a steep discount. What is needed is a return policy model that determines a cost of returning an item to a variety of different return locations (e.g., a store or a distribution center) and then select the location with the optimal expected recovery.

### SUMMARY

According to one embodiment of the present invention, a method includes receiving a return order identifying an item to be returned via mail and determining, using one or more computer processors, a net expected recovery for a plurality of candidate return locations. Further, determining the net expected recovery includes predicting expected future cost incurred when transferring the item to, and selling the item from, each of the plurality of candidate return locations and predicting expected future revenue based on a demand forecast for the item at each of the plurality of candidate return locations where the expected future revenue is the payment received when selling the item from each of the plurality of candidate return locations. The method includes selecting, based on the net expected recovery, one of the plurality of candidate return locations as a return location to be used to return the item. Advantageously, this method treats returned items as additional inventory that can be used to replenish inventory that is at a particular location. This in turn means the inventory is better distributed to satisfy demand and increase the likelihood the items are re-sold at a good price, thereby increasing expected future revenue.

Another embodiment of the present invention includes the embodiment above and determining the net expected recovery may further include, predicting expected demand imbalance transfer costs associated with each of the plurality of candidate return locations, the expected demand imbalance transfer costs indicates a likelihood the item will be transferred at a future time from the return location to a different location in a retailer's network in order to satisfy a demand imbalance between the plurality of candidate return locations. Advantageously, considering the expected demand imbalance transfer costs when calculating the net expected recovery increases the likelihood the items are returned to a location (e.g., a distribution center) with demand deficit so as to avoid inventory transfer.

Another embodiment of the present invention includes the embodiments above and determining the net expected recovery may further include, determining operational transfer costs associated with each of the plurality of candidate return locations, the operational transfer costs include codes associated with retrieving the item from the return location and transferring the item from the return location to another location. Advantageously, considering the operational transfer costs when calculating the net expected recovery increases the likelihood that items are returned to locations where they will not need to be transferred from at a future time.

Another embodiment of the present invention includes the embodiments above where the return order comprises multiple items and the method further includes identifying eligible locations for each of the multiple items from a list of potential return locations in a retailer's network where at least one of the multiple items cannot be returned to at least one of the potential return locations and identifying the plurality of candidate return locations from the eligible locations where the plurality of candidate return locations are locations where all of the multiple items are eligible to be returned and where the net expected recovery is not calculated for any of the potential return locations that are not include in the plurality of candidate return locations. Advantageously, this enables the return optimizer to consider common locations so that multiple items can be returned to the same location and can also reduce the number of locations for which the net expected recovery is calculated, thereby saving processing time and compute resources.

Another embodiment of the present invention includes the embodiments above where the method includes updating inventory and return capacity information corresponding to the return location in response to selecting the return location. Doing so advantageously updates the inventory and the return capacity so that more optimal decisions can be made when future return orders are received.

Another embodiment of the present invention includes the embodiments above where the method includes determining an expected future margin for selling the item at each of the plurality of candidate return locations based on the expected future revenue and the expected future cost. Advantageously, the future margin represents a loss or profit, and thus, provides an important metric a retailer might want to consider when making return decisions.

Another embodiment of the present invention includes the embodiments above where the method includes determining shipping cost incurred for shipping the item to each of the plurality of candidate return locations where the shipping cost is determined after receiving the return order but the expected future cost and the expected future revenue are determined before the return order is received. Advantageously, the expected future costs and expected future revenue are pre-computed, which increases the response time of the system so that the return decisions can be made faster relative to a system that determines the expected future costs and revenue in response to receiving a return order.

### BRIEF DESCRIPTION OF THE SEVERAL VIEWS OF THE DRAWINGS

FIG. 1 is a block diagram of a system for selecting an optimal return location using a net expected recovery, according to one embodiment described herein.

FIG. 2 is a flowchart for selecting an optimal return location using a net expected recovery, according to one embodiment described herein.

FIG. 3 is a block diagram of a system for selecting an optimal return location using a net expected recovery, according to one embodiment described herein.

FIG. 4 is a flowchart for processing a return order containing multiple items, according to one embodiment described herein.

FIG. 5 is a flowchart for determining the net expected recovery for a plurality of candidate return locations, according to one embodiment described herein.

FIGS. 6A and 6B illustrate predicting expected future revenue for a particular return location, according to embodiments described herein.

FIG. 7 depicts a cloud computing environment according to an embodiment described herein.

FIG. 8 depicts abstraction model layers according to an embodiment described herein.

### DETAILED DESCRIPTION

The embodiments herein provide techniques for selecting an optimal return location from a plurality of candidate return locations for returning an item based on a determined expected recovery associated with each location. As discussed above, using predesignated return location(s) ignores many factors that can increase costs that affect returning items such as shipping costs, inventory, handling costs, operational transfer costs, as well as several predicted costs. Further, these techniques do not consider expected future revenue (which can offset these costs). For example, shipping a return item to a distribution center typically means the item must be sold online or shipped to another store before it can be sold. However, if the item is instead returned to a store, the item can be sold to a walk-in customer, and as a result, the distribution center can have a different expected revenue than the store. Further, if the item is shipped to one store with high demand and low stock for the item, it will have different expected revenue impact than if shipped to a different store with low demand and high stock for the item.

In one embodiment, a net expected recovery is determined for each location using the expected costs and future revenues discussed above. By comparing the net expected recovery associated with each candidate return location (e.g., a distribution center, physical store, kiosk, re-packaging center, etc.), the optimal return location can be identified (e.g., where the cost is minimized or the revenue is maximized or the net recovery is maximized). A shipping label containing the address of the optimal return location can then be provided to the customer who ships the returned item to the location.

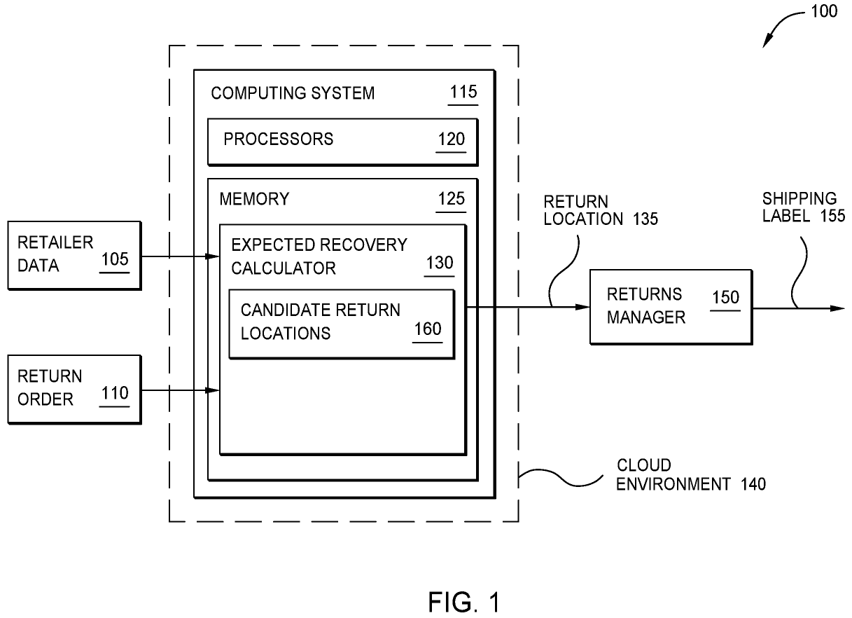

FIG. 1 is a block diagram of a system 100 for selecting an optimal return location 135 using a net expected recovery, according to one embodiment described herein. The system 100 includes a cloud environment 140 which hosts a computing system 115 which can include any number of different computing devices. The computing system 115 includes multiple processors 120 which represent any number of processing elements that can each have any number of processing cores. The computing system 115 also includes memory 125 that can include volatile and nonvolatile memory elements that store an expected recovery calculator 130.

In one embodiment, the expected recovery calculator 130 is a software application (or applications) executing in the cloud environment 140 that determines a net expected recovery for each of the candidate return locations 160. In one embodiment, the candidate return locations 160 represent different geographical or physical locations where an item purchased from a retailer can be returned. These locations 160 can be locations controlled by the retailer (e.g., a distribution center, re-packaging center, or physical store for the retailer) or a third-party location which has a contract or agreement with the retailer to accept their mailed returned items.

The expected recovery calculator 130 uses retail data 105 and a return order 110 to determine the net expected recovery for each of the candidate return locations 160. The net expected recovery can be net cost or net revenue corresponding to returning an item or items specified in the return order 110 to each of the candidate return locations 160. In one embodiment, the net expected recovery can be thought of as a score used to compare the locations 160 in order to select an optimal return location 135 for the items in the return order 110. In one embodiment, the net expected recovery can be expressed as in Equation 1.

Net Expected Recovery=Expected Future Revenue−Return Shipping Cost−Return Handling Cost−Operational Transfer Cost−Expected Demand Imbalance Transfer Cost−Expected Future Cost (1)

Although the terms for calculating the net expected recovery are described in more detail below, in brief, the expected future revenue is the payment predicted to be received when the returned items are sold after reaching the location, the return shipping cost is the cost for shipping the items in the return order to a particular candidate location, the operational transfer cost is the cost for shipping the returned items to a different location (assuming the candidate location is an intermediate location), the expected demand imbalance transfer cost is a predicted cost related to having to move the returned items to a different location in response to demand imbalance, and the expected future cost is a cost predicted to be incurred when transferring the item to the candidate location and selling the returned items after they have been received at the candidate location.

Once the net expected recovery is calculated for each location 160, the expected recovery calculator 130 can select the return location 135 with the optimal net expected recovery—e.g., the candidate return location 160 with the lowest cost or the highest revenue. The system 100 includes a returns manager 150 that uses the return location 135 to generate a shipping label 155 which the customer can use to return the items in the return order 110 to the return location 135. For example, the shipping label 155 may include the address of the return location 135 printed on it or embedded within a bar code or other graphical representation.

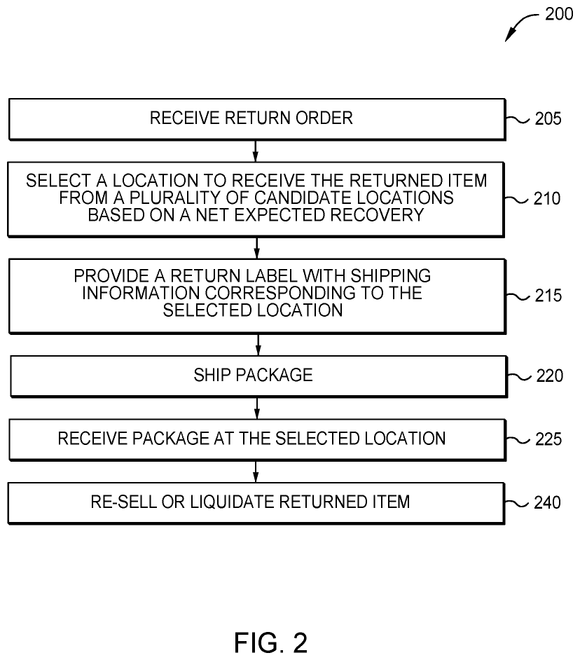

FIG. 2 is a flowchart of a method 200 for selecting an optimal return location using a net expected recovery, according to one embodiment described herein. At block 205, the expected recovery calculator receives a return order initiated by a customer. In one embodiment, the return order indicates the number and type of items the customer wants to return. Further, the return order can specify the region (or zone) where the customer lives. As discussed below, the geographical location of the customer can be used to estimate the shipping cost for shipping the returned items to the different candidate return locations.

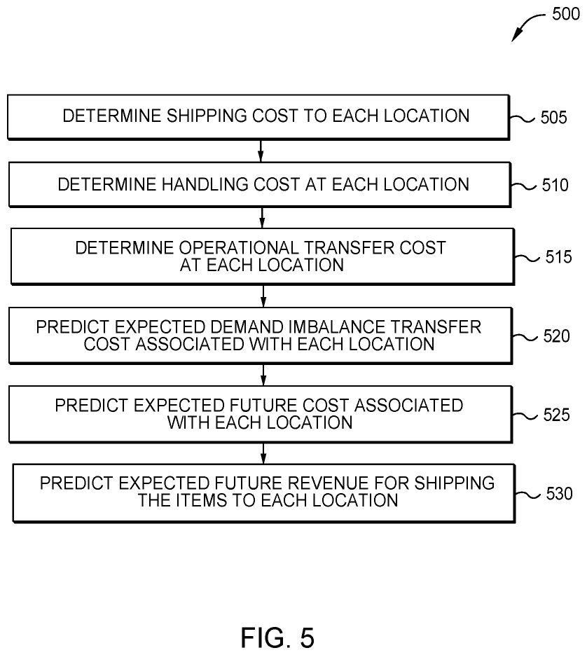

At block 210, the expected recovery calculator selects a location to receive the returned item from a plurality of candidate locations based on the net expected recovery. Although described in more detail in FIG. 5, the expected recovery calculator can calculate a net expected recovery for each of the candidate locations in the network of the retailer using Equation 1. The expected recovery calculator can then select the candidate location with the best net expected recovery.

At block 215, the returns manager provides a return label with shipping information corresponding to the selected location (i.e., the return location) to the customer. For example, the return label may have the physical address of the selected location. Alternatively, the return label may have a 1D or 2D barcode that encodes the address of the selected location.

At block 220, the customer ships a package containing the returned items using the return label. The embodiments herein are not limited to any particular technique for shipping the package with the returned items to the selected location.

At block 225, the package is received at the selected location. In one embodiment, the selected location may be a distribution center where the returned items can be stored. In another embodiment, the selected location is a store where the returned items can be re-packaged (if necessary) and then put out for sell or stored as inventory. In another embodiment, the selected location is a re-packaging center that specializes in re-packaging returned items so the items can then be shipped to a distribution center or a store for re-sell.

At block 240, the returned items are re-sold or liquidated. For example, the returned items in a distribution center may be sold to an online customer, or the returned items may be transferred to a physical store when the store's inventory of that item is low or depleted. If a store or distribution center has too many of the returned items, the items may be liquidated as part of a sale that offers discounts.

One advantage of method 200 is it treats returned items as additional inventory that can be used to replenish inventory that is at a particular location. That is, when calculating the net expected recovery for the candidate locations, one factor is the current inventory of these locations. For example, a location that currently has a small inventory of the items being returned may have a higher net expected recovery than another location with a larger inventory of the items (assuming all the other factors are equal). Similarly, expected future demand based on demand forecasts can also be used to better estimate expected recover, preferring locations with both lower inventory, and higher demand, for the given return item.

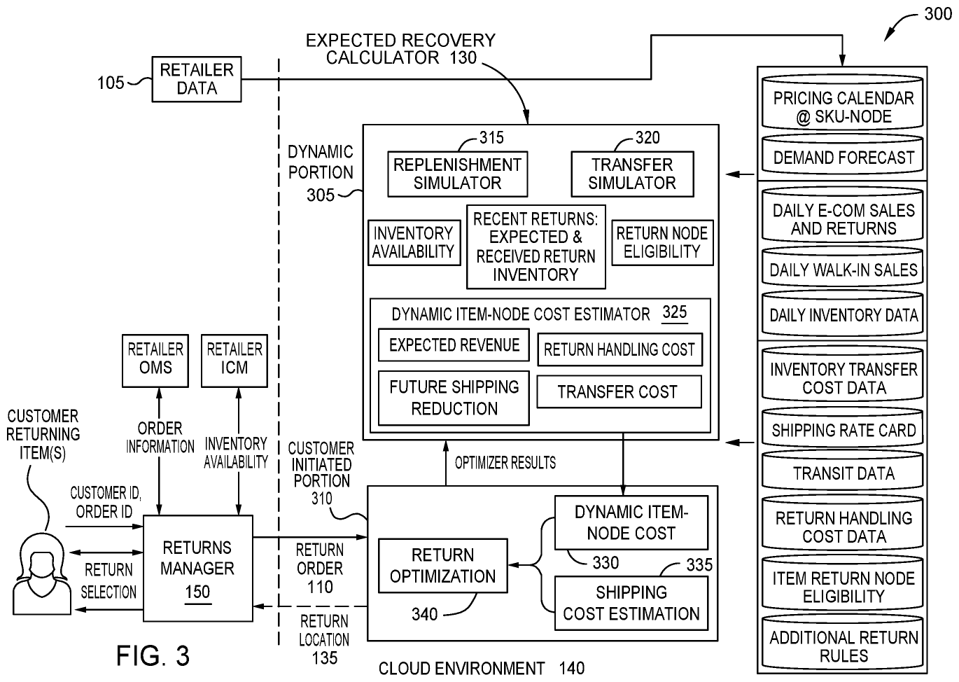

FIG. 3 is a block diagram of a system 300 for selecting an optimal return location using a net expected recovery, according to one embodiment described herein. As shown, the cloud environment 140 receives the retailer data 105 from, e.g., a data center associated with the retailer. The retailer data 105 can include a pricing calendar indicating how the prices of items sold by the retailer change over time (e.g., when the items are normally priced versus a sale price). The data 105 can include a demand forecast indicating the online and walk-in demand for an item. The walk-in demand can be on a per store basis which can vary. In one embodiment, the pricing calendar and the demand forecast are updated periodically (e.g., weekly). The demand forecast can also include the demand on channels such as online versus walk-in at physical locations, or other channels such as third party web channels and mobile sales. Channel demand has can have geographic information as well, namely what region the online demand is coming from. More demand may come from a region in the east coast of the United Stated relative to the rest of the United States, for example. Thus, the return optimizer we may want to position the inventory to meet that demand, even though it is all online demand, by putting more inventory on an east coast versus west-coast, or even in stores near the region.

The retailer data 105 can also include daily e-commercial (e-com) or online sales and returns for the items offered by the retailer, daily walk-in sales indicating the sales of each item at each physical store, and daily inventory data indicating the amount of each item stored at the various locations in the retailer's network. As indicated, these types of retailer data 105 may be updated every day.

The retailer data 105 can also include the inventory transfer cost data indicating the amount it costs to transfer the items being offered to sale from one location in the retailer's network to another location, a shipping rate card indicating the shipping costs for shipping the items from various geographic locations (to each candidate location in the retailer's network), and transit data indicating the transit times for sending different packages to different locations via different modes (e.g., for one origin-destination pair it may take 3 days versus 2 days for another). The transit times may not be purely distance-based and can depend on the shipping carrier—e.g., two location might be farther apart but located right along the highway on a regular route between hubs, so may have fewer transit days. The retailer data 105 also includes return handling cost data indicating the cost incurred for processing the returned items so they are in a state ready for re-sell. The return handling cost data can vary greatly between locations; for example, a store may have only one person assigned to process returned items with little specialized training and infrastructure to help. However, a re-packing center or distribution center may have several individuals with special training for processing returned items for re-sell.

The retailer data 105 also includes item return node eligibility indicating which locations (i.e., which nodes in the retailer's network) are permitted to receive which returned items. For example, some return items may have to go to a re-packaging center since they require specialized tools to be ready for re-sell. In another example, the items may have particular significance to a particular geographic region (such as a sports team or weather related gear), and thus, may need to be returned to a location within that geographic region. For example, the retailer may not want a surfboard being returned to a store that is more than 200 miles from the coast.

The retailer data 105 can also include additional return rules such as indicating that certain items should always be returned to a particular subset of the candidate locations. Thus, the retailer can control the actions of the expected recovery calculator 130 to make sure the correct return location is selected in specific scenarios. The inventory transfer cost data, shipping rate card, transit data, return handling cost data, item return node eligibility, and additional return rules may be sent only once to the cloud environment 140, or may be updated periodically or ad hoc.

The retailer data 105 serves as inputs to the expected recovery calculator 130. In this example, the calculator 130 includes a dynamic portion 305 and a customer initiated portion 310. In general, the dynamic portion 305 includes elements (e.g., software applications or modules) that execute as the retailer data 105 is updated. That is, when the cloud environment 140 receives new retailer data 105, some or all of the dynamic portion 305 executes in order to update its stored information. In one embodiment, the dynamic portion 305 stores information used to calculate the net expected recovery for each of the candidate locations.

The customer initiated portion 310, in contrast, may execute in response to receiving a return order 110 from a customer. That is, while the dynamic portion 305 may constantly perform its functions (which are described below) as the retailer data 105 updates, the customer initiated portion 310 may execute when a new return order 110 is received.

The dynamic portion 305 includes a replenishment simulator 315, a transfer simulator 320, and a dynamic item-node cost estimator 325. The replenishment simulator 315 (or replenishment predictor) predicts when a store's inventory will need to be resupplied from a distribution center. The transfer simulator 320 (or transfer predictor) predicts when items will need to be transferred between distribution centers to avoid demand-supply imbalance. Thus, the replenishment simulator 315 predicts when stores (which sell goods to walk-in customers) need additional inventory while the transfer simulator 320 predicts when inventory will be transferred between distribution centers.

The dynamic item-node cost estimator 325 uses the retail data 105 to calculate the expected revenue, return handling cost, future shipping reduction, and transfer cost corresponding to each candidate location and for each item. For example, the estimator 325 may determine these metrics for each item sold by the retailer and for each candidate location. As mentioned above, the estimator 325 can calculate these metrics each time the retailer data 105 is updated. Thus, whenever a return order 110 is received, the dynamic item-node cost estimator 325 has already calculated the metrics for each candidate location and item.

In one embodiment, the dynamic item-node cost estimator 325 uses the listed metrics to generate a dynamic item-node cost 330. For example, the estimator 325 may calculate a dynamic item-node cost 330 for each item and location combination. That is, the dynamic item-node cost estimator 325 can calculate a dynamic item-node cost 330 for each item at each of the candidate locations. These costs 330 can be pre-computed (e.g., computed before a return order 110 is received) and can be stored in a look-up table for quick access once a return order is received. For example, once a return order 110 is received by the customer initiated portion 310, the portion 310 can inform the dynamic item-node cost estimator 325 what item (or items) are in the returned order 110. In response, the dynamic item-node cost estimator 325 can return the dynamic item-node costs 330 for that item at each of the candidate locations. Because these costs 330 were pre-computed, the costs 330 can advantageously be identified quicker relative to embodiments that calculate the costs 330 after receiving the return order 110.

To help with calculating the dynamic item-node costs 330, the dynamic portion 305 also determines the inventory availability at the various candidate return locations. The dynamic portion 305 also determines the recent returns at each location which can include the returns that have been received as well as the expected returns (i.e., the returns that are currently in-route to the locations, but have not yet arrived). Further, the dynamic portion 305 can determine the return node eligibility to identify what candidate locations are permissible locations for a particular item and which are not.

The customer initiated portion 310 uses the dynamic item-node costs 330 received from the estimator 325 and a shipping cost estimation 335 to perform return optimization 340. In one embodiment, the shipping cost estimation 335 is performed using information provided in the return order 110 such as the geographic location of the customer who is returning the items, the number of items, their weight, etc. Since this information can affect the shipping cost estimation 335, this may be calculated only after receiving the return order 110 unlike the dynamic item-node cost 330 which can be computed independently of the information in the return order 110.

In one embodiment, the return optimization 340 determines the net expected recovery using the dynamic item-node cost 330 and the shipping cost estimation 335 for each candidate location. The return optimization 340 can then report the optimal return location 135 to the returns manager 150. In response, the returns manager 150 can provide a return label to the customer. For example, the customer may take the returned items to a shipping center or post office where the return label is printed and affixed to the package. Alternatively, the returns manager 150 can provide a digital image of the return label which the customer can print and attach to the package.

Moreover, information about the return—e.g., the order information and the inventory availability—can be provided to the retailers order management system (OMS) and inventory and capacity management system (ICM). That is, because the expected recovery calculator 130 has identified a return location, this information can be provided to the retailer ICM so it knows that more inventory is heading its way.

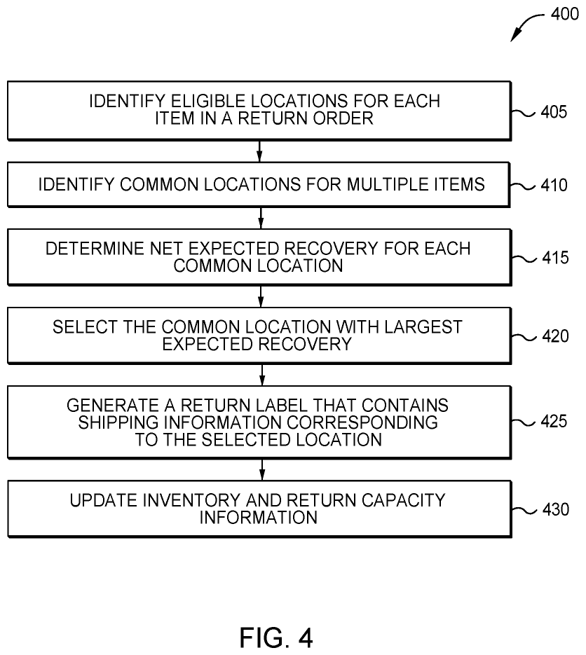

FIG. 4 is a flowchart of a method 400 for processing a return order containing multiple items, according to one embodiment described herein. At block 405, the expected recovery calculator identifies eligible locations for each item in a return order. As mentioned above, the retailer may provide item return node eligibility data limiting what candidate return locations can receive certain items. As such, not every candidate return location in a retailer's network may be considered as an eligible location for every item sold by the retailer.

At block 410, the expected recovery calculator identifies common locations for multiple items. For example a first item in the return order can only be returned to Locations A, E, G, and F while a second item in the return order can only be returned to Locations B, C, D, E, and F. Rather than having a customer prepare two return shipments (which harms the customer experience and essentially doubles the shipping costs), the expected recovery calculator can identify the common location or locations where all the items in a return order can be returned. In the example above, the common locations are Location E and F. If there is only one common location, then that location wins be default and blocks 415 and 420 can be omitted. However, method 400 assumes there are at least two common locations for returning the items in the return order.

At block 415, the expected recovery calculator determines the net expected recovery for each common location. This may be based on Equation 1. Other embodiments for calculating the net expected recovery are also discussed in FIG. 5 below.

At block 420, the expected recovery calculator selects the common location with the largest expected recovery. That is, the calculator selects the location that minimizes costs (or maximizes revenue) relative to the other common locations identified at block 415.

At block 425, the returns manager generates a return label that contains shipping information corresponding to the selected location.

At block 430, the returns manager updates inventory at return capacity information for the selected location. That is, the returned items can be classified as expected returns and can be added to the inventory to the selected location on a provisional basis. The returns manager can indicate when the items are estimated to arrive and the selected location. Further, the returned items can affect the return capacity of the selected location indicating the ability of the staff at the location to process returns. Both the inventory and the returned capacity of the locations can affect the net expected recovery, and thus, performing block 430 can cause the dynamic portion 305 of the expected recovery calculator 130 in FIG. 3 to re-calculate the dynamic item-node cost for the selected location so that the net expected recovery of the selected location is up-to-date when a new return order is received.

FIG. 5 is a flowchart of a method 500 for determining the net expected recovery for a plurality of candidate return locations, according to one embodiment described herein. While Equation 1 and the method 500 illustrate a set of metrics that can be used to calculate the net expected recovery for a location, the embodiments are not limited to such. There are separate advantages with each metric described in method 500, and thus, it may be advantageous for one implementation to include some of the metrics described in the method 500, but not all. For example, in one embodiment, the net expected recovery is calculated based on shipping cost, operational cost, and expected future revenue but not based on handling cost or expected demand imbalance transfer costs. Thus, the embodiments herein contemplate that the net expected recovery can be determined using any combination or sub-combination of the metrics listed in Equation 1 or the method 500.

At block 505, the expected recovery calculator determines the shipping cost of the items in the return order for each location (i.e., each common location shared by the items). Advantageously, considering the shipping costs recognizes that the customer may be located in various geographic locations with varying distances to the candidate return locations. As a result, the cost for shipping the item or items from the customer to the return locations can vary greatly.

In one embodiment, the shipping cost for each location is determined by identifying the postal codes (e.g., zip codes) for the customer and the returns locations. The expected recovery calculator can also determine the list of available post carriers and the available shipping methods for shipping the items (e.g., ground, air, express, etc.). The expected recovery calculator can retrieve the weight of the items to calculate the combined weight of the return order. The expected recovery calculator can then compute the shipping costs based on the shipping zone, number of shipping days, and weight of the order (and dimensions of the package if this affects shipping costs).

At block 510, the expected recovery calculator determines handling costs at each location. Advantageously, considering handling costs recognizes that the cost for processing the returned package at each location can vary depending on the number of trained staff, their availability, and the equipment available at each location. In one embodiment, handling cost and load balancing cost are combined into a single model that can be adjusted based on the retailer's input. Return order's arrival at a location and processing the returned items depends on factors such as customer's delay in mailing the package from label creation date, weekend effects, and processing start and delay in processing itself. Given this uncertainty, it is difficult if not impossible to precisely compute the exact load (units to be processed) for a given future day. Instead, in one embodiment, the expected recovery calculator attempts to keep load balanced during a window of days by ensuring that load on any particular deterministic arrival day is below upper capacity limit and average load between deterministic arrival day plus next few days within uncertainty band remains below capacity limit. If both these conditions are true, the total return handling cost is used as the load balancing cost. If one of these conditions is not true, the total return handling cost plus an additional penalty are used as the load balancing cost. The penalty can be a high number to discourage the location for being selected as the return location.

At block 515, the expected recovery calculator determines operational transfer costs at each location. The operational transfer costs define the cost for moving the items from the return location to a different location in the retailer's network. This cost can include retrieving (or picking) the item from the location, transferring the item to a new location in the network, processing the item at the new location, and putting away the item at the new location. For example, the operational transfer costs for a distribution center are generally smaller than at a physical store since the distribution center is designed for the easy retrieval of items and moving those items to a different location. Thus, if it is likely an item will be transferred in the future (i.e., after it has been received at a return location), a location having a higher operational transfer costs will generally have a worse net expected recovery than a location with a lower operational transfer cost.

At block 520, the expected recovery calculator predicts the expected demand imbalance transfer cost associated with each location. In the retailer's network, inventory transfers may be performed across distribution centers to avoid demand-supply imbalance. The idea is to have inventory in proximity to the online demand. The advantage of considering the expected demand imbalance transfer cost when calculating the net expected recovery is that doing so increases the likelihood the items are returned to a location (e.g., a distribution center) with demand deficit so as to avoid inventory transfer. Thus, the expected demand imbalance transfer cost may increase as the inventory of the item at a particular location increases. However, this can be offset if the demand for the item at the location is also high. That is, even if the location has a very high inventory of an item, if it also has high demand, then the expected demand imbalance transfer cost may be low. However, if the location has high inventory but low demand, then the expected demand imbalance transfer cost may be high since the likelihood that a transfer of the items may need to be performed in the future increases. Thus, assigning a high expected demand imbalance transfer cost reduces the chance the location is selected as the return location, and thus, reduces the chance that an imbalance transfer will occur in the future.

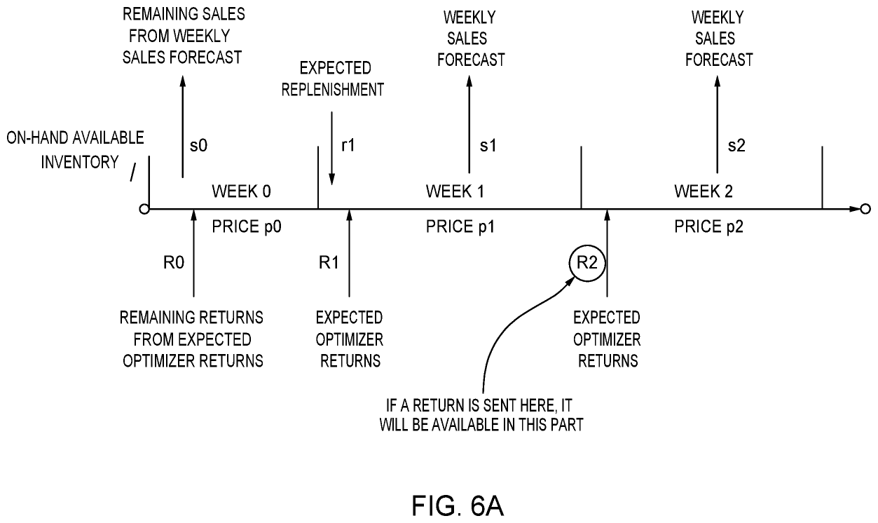

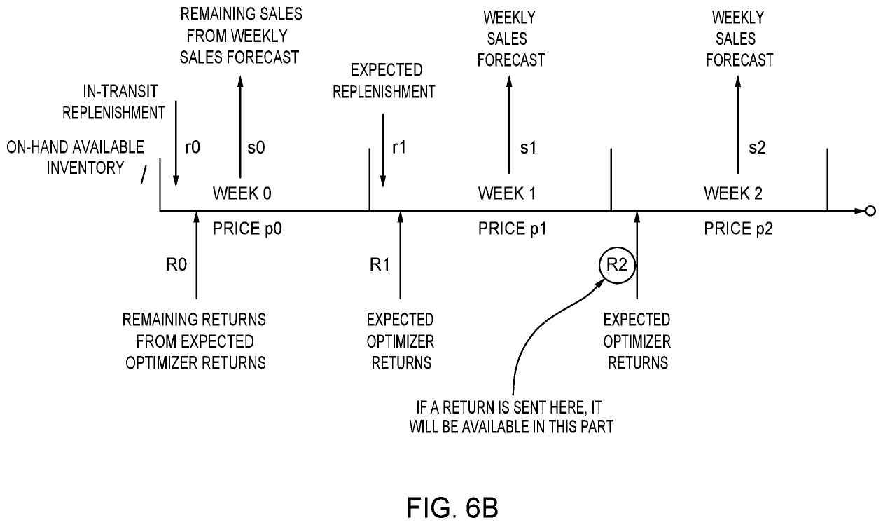

At block 525, the expected recovery calculator predicts the expected future cost associated with each location, which is the cost incurred when selling the items. The cost can vary for each location and could include restock costs, sale at discounted price due to lost opportunity, and future handling and shipping costs. At block 530, the expected recovery calculator predicts the expected future revenue for each location. The expected future revenue can vary depending on the demand forecast (e.g., a weekly sale forecast) for each of the candidate return locations. Further, the expected future revenue depends on the price of the item, which can vary based on a price calendar or on ad hoc sales or liquidations if there are too many items in the inventory. Examples of calculating the expected future revenue are provided in FIGS. 6A and 6B below.

Subtracting the expected future cost from the expected future revenue yields the expected future margin associated with selling the item. This margin can be a positive margin (indicating the retailer made a profit from selling the item) or a negative margin (indicating the retailer suffered a loss from selling the item). The expected future revenue can vary depending on the price of the item, which can vary depending on the location. For example, some locations may have a low demand for the items, which means the price may need to be decreased for the item to sell, thereby shrinking the expected future margin. However, other locations may have strong demand for the item, in which case the price of the item may be more. But this might be offset by increased expected future costs incurred at that location. Advantageously, considered the expected future margin at each location can better predict whether the retailer will make better margins when selling the item. This margin can be offset from the costs described above in blocks 505-520.

As shown in Equation 1, the metrics described in the method 500 can be combined to calculate in the net expected recovery for each location. Again, the net expected recovery does not have to consider all these metrics but may consider a sub-combination of these metric. Further, the net expected recovery can depend on other metrics. For example, the expected recovery calculator may also consider future shipping costs when calculating the net expected recovery. For distribution centers, the future shipping cost can be divided into two types: in-zone shipping costs and out-of-zone shipping costs. If a distribution center has sufficient inventory to satisfy in-zone demand (decided by proximity), then the expected recovery calculator assumes in-zone future shipping cost dominate the future shipping costs. Else the expected recovery calculator computes average out of zone shipping cost as the future shipping costs.

FIGS. 6A and 6B illustrate predicted expected revenue for a particular return location, according to one embodiment described herein. That is, FIGS. 6A and 6B illustrate different embodiments for predicting expected future revenue at a location (e.g., block 530 of the method 500). FIG. 6A illustrates that expected revenue from a returned item at a location is computed based on combining expected inventory picture and expected pricing calendar data. For this purpose, all data elements are tracked (e.g., at a weekly level).

In one embodiment, the expected recovery calculator predicts the first week when the current return will be sold as part of a walk-in sale. The “/” in FIG. 6A is the starting inventory at the store, which is the end of the day inventory from the previous day. The expected incoming inventory is due to expected replenishments and expected online return decisions made by the expected recovery calculator. The expected returns for each week are kept track of and when an actual returns arrives, the items are removed from the expected return list. The expected outgoing inventory is due to sales forecast (e.g., at a weekly level). For the current week, the expected recovery calculator updates forecast for the remaining duration by updating with respect to the actual sale data from the walk-in customers.

In FIG. 6B, r0, r1, R0, R1, R2, s1, s2, s3, p0, p1, p2, and so forth, are precomputed and updated at the end of each day. If the inventory at the location never runs out before the end of a demand forecast available window, the expected recovery calculator assumes the price to be a certain % markdown of the list price in previous weeks, which can be confirmed by the retailer. In one embodiment, the expected revenue is assumed to be a deterministic model. However, it is possible to build a machine learning (ML) model that directly predicts whether an item will stock out and when. The expected recovery calculator can directly use the ML model to compute price during that time period. Also, the model uncertainty can add richness to the decision making. For e-commerce, the expected recovery calculator can use the same logic, but with an online price calendar and accounting for new inventory arrival at the distribution center.

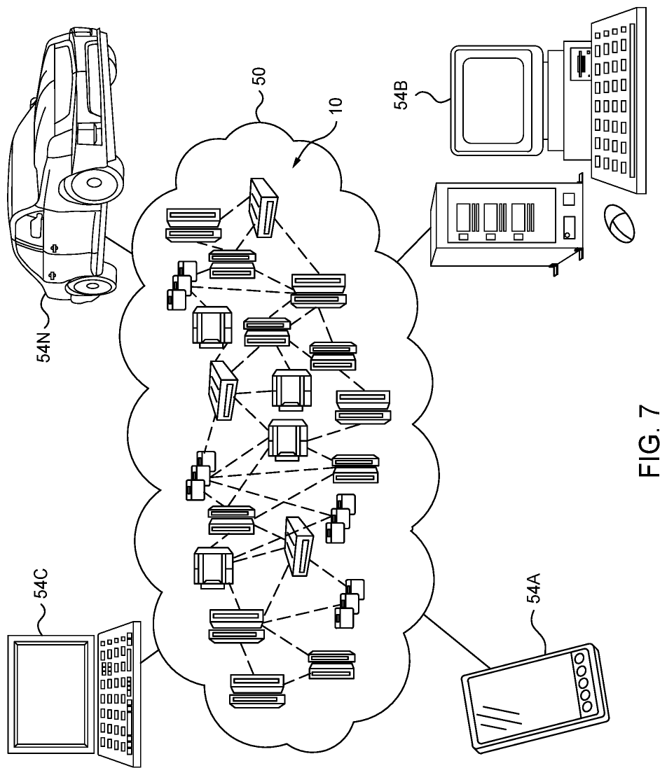

FIG. 7 depicts a cloud computing environment according to an embodiment of the present invention. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

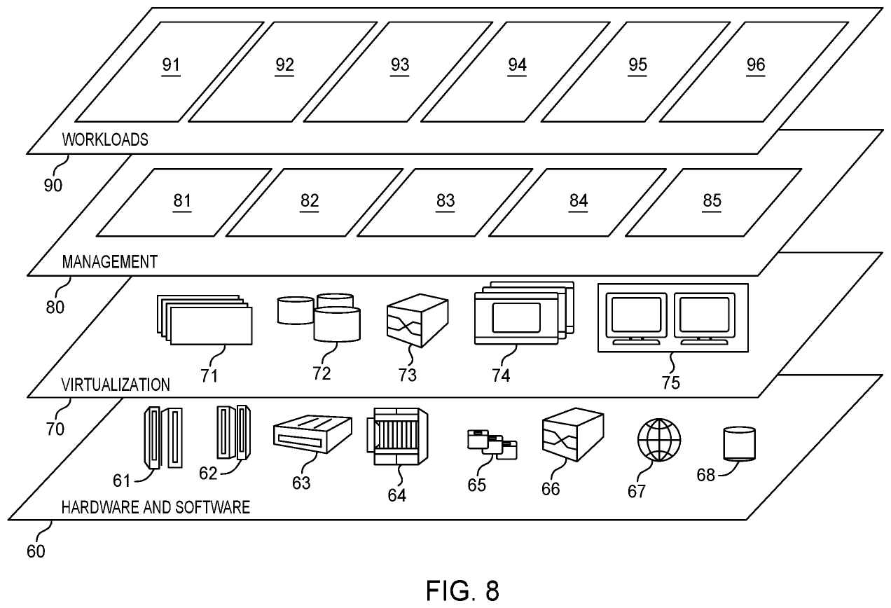

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and an recovery calculator 96 (e.g., the expected recovery calculator 130 in FIG. 1) that selects a return location from a plurality of candidate return locations in response to determining the expected recovery for each location.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements described above, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed above are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method comprising:
receiving a return order identifying an item to be returned via mail;
determining, using one or more computer processors, a net expected recovery for a plurality of candidate return locations, wherein determining the net expected recovery comprises:
predicting expected future cost incurred when transferring the item to, and selling the item from, each of the plurality of candidate return locations; and
predicting expected future revenue based on a demand forecast for the item at each of the plurality of candidate return locations, wherein the expected future revenue is the payment received when selling the item from each of the plurality of candidate return locations; and
selecting, based on the net expected recovery, one of the plurality of candidate return locations as a return location to be used to return the item.

2. The method of claim 1, wherein determining the net expected recovery comprises:
predicting expected demand imbalance transfer costs associated with each of the plurality of candidate return locations, the expected demand imbalance transfer costs indicates a likelihood the item will be transferred at a future time from the return location to a different location in a retailer's network in order to satisfy a demand imbalance between the plurality of candidate return locations.

3. The method of claim 1, wherein determining the net expected recovery comprises:
determining operational transfer costs associated with each of the plurality of candidate return locations, the operational transfer costs include codes associated with retrieving the item from the return location and transferring the item from the return location to another location.

4. The method of claim 1, wherein determining the net expected recovery comprises:
determining handling costs associated with each of the plurality of candidate return locations, the handling costs include cost for processing the item of the plurality of candidate return locations varies depending on a number of trained staff at the plurality of candidate locations, an availability of trained staff, and equipment available at each of the plurality of candidate locations.

5. The method of claim 1, wherein the return order comprises multiple items, the method further comprising:
identifying eligible locations for each of the multiple items from a list of potential return locations in a retailer's network, wherein at least one of the multiple items cannot be returned to at least one of the potential return locations; and
identifying the plurality of candidate return locations from the eligible locations, wherein the plurality of candidate return locations are locations where all of the multiple items are eligible to be returned, wherein the net expected recovery is not calculated for any of the potential return locations that are not include in the plurality of candidate return locations.

6. The method of claim 1, further comprising:
updating inventory and return capacity information corresponding to the return location in response to selecting the return location.

7. The method of claim 1, further comprising:
determining an expected future margin for selling the item at each of the plurality of candidate return locations based on the expected future revenue and the expected future cost.

8. The method of claim 1, wherein determining the net expected recovery comprises:
determining shipping cost incurred for shipping the item to each of the plurality of candidate return locations, wherein the shipping cost is determined after receiving the return order but the expected future cost and the expected future revenue are determined before the return order is received.

9. A system, comprising:
a processor; and
memory comprising a program, which when executed by the processor performs an operation, the operation comprising:
receiving a return order identifying an item to be returned via mail;
determining, using one or more computer processors, a net expected recovery for a plurality of candidate return locations, wherein determining the net expected recovery comprises:
predicting expected future cost incurred when selling the item from each of the plurality of candidate return locations; and
predicting expected future revenue based on a demand forecast for the item at each of the plurality of candidate return locations, wherein the expected future revenue is the payment received when selling the item from each of the plurality of candidate return locations; and
selecting, based on the net expected recovery, one of the plurality of candidate return locations as a return location to be used to return the item.

10. The system of claim 9, wherein determining the net expected recovery comprises:
predicting expected demand imbalance transfer costs associated with each of the plurality of candidate return locations, the expected demand imbalance transfer costs indicates a likelihood the item will be transferred at a future time from the return location to a different location in a retailer's network in order to satisfy a demand imbalance between the plurality of candidate return locations.

11. The system of claim 9, wherein determining the net expected recovery comprises:
determining operational transfer costs associated with each of the plurality of candidate return locations, the operational transfer costs include codes associated with retrieving the item from the return location and transferring the item from the return location to another location.

12. The system of claim 9, wherein determining the net expected recovery comprises:
determining handling costs associated with each of the plurality of candidate return locations, the handling costs include cost for processing the item of the plurality of candidate return locations varies depending on a number of trained staff at the plurality of candidate locations, an availability of trained staff, and equipment available at each of the plurality of candidate locations.

13. The system of claim 9, wherein the return order comprise multiple items, the operation further comprising:
identifying eligible locations for each of the multiple items from a list of potential return locations in a retailer's network, wherein at least one of the multiple items cannot be returned to at least one of the potential return locations; and
identifying the plurality of candidate return locations from the eligible locations, wherein the plurality of candidate return locations are locations where all of the multiple items are eligible to be returned, wherein the net expected recovery is not calculated for any of the potential return locations that are not include in the plurality of candidate return locations.

14. The system of claim 9, wherein the operation further comprises:
updating inventory and return capacity information corresponding to the return location in response to selecting the return location.

15. A computer program product for selecting a return location for an item to be returned via mail, the computer program product comprising:
a computer readable storage medium having computer readable program code embodied therewith, the computer readable program code executable by one or more computer processors to perform an operation, the operation comprising:
receiving a return order identifying the item;
determining, using one or more computer processors, a net expected recovery for a plurality of candidate return locations, wherein determining the net expected recovery comprises:
predicting expected future cost incurred when selling the item from each of the plurality of candidate return locations; and
predicting expected future revenue based on a demand forecast for the item at each of the plurality of candidate return locations, wherein the expected future revenue is the payment received when selling the item from each of the plurality of candidate return locations; and
selecting, based on the net expected recovery, one of the plurality of candidate return locations as the return location to be used to return the item.

16. The computer program product of claim 15, wherein determining the net expected recovery comprises:
predicting expected demand imbalance transfer costs associated with each of the plurality of candidate return locations, the expected demand imbalance transfer costs indicates a likelihood the item will be transferred at a future time from the return location to a different location in a retailer's network in order to satisfy a demand imbalance between the plurality of candidate return locations.

17. The computer program product of claim 15, wherein determining the net expected recovery comprises:
determining operational transfer costs associated with each of the plurality of candidate return locations, the operational transfer costs include codes associated with retrieving the item from the return location and transferring the item from the return location to another location.

18. The computer program product of claim 15, wherein determining the net expected recovery comprises:
determining handling costs associated with each of the plurality of candidate return locations, the handling costs include cost for processing the item of the plurality of candidate return locations varies depending on a number of trained staff at the plurality of candidate locations, an availability of trained staff, and equipment available at each of the plurality of candidate locations.

19. The computer program product of claim 15, wherein the return order comprises multiple items, the operation further comprising:
identifying eligible locations for each of the multiple items from a list of potential return locations in a retailer's network, wherein at least one of the multiple items cannot be returned to at least one of the potential return locations; and
identifying the plurality of candidate return locations from the eligible locations, wherein the plurality of candidate return locations are locations where all of the multiple items are eligible to be returned, wherein the net expected recovery is not calculated for any of the potential return locations that are not include in the plurality of candidate return locations.

20. The computer program product of claim 15, wherein the operation further comprises:
updating inventory and return capacity information corresponding to the return location in response to selecting the return location.
